(19) United States
(12) Patent Application Publication
(10) Pub. No.: US 2011/0050411 A1
(43) Pub. Date: Mar. 3, 2011

(54) INTEGRATED HEALTHCARE COMMUNICATION AND LOCATING SYSTEM

(76) Inventors: Richard J. Schuman, Cary, NC (US); Danny Charles Woodward, II, Cary, NC (US)

(21) Appl. No.: 12/872,227

(22) Filed: Aug. 31, 2010

Related U.S. Application Data
(60) Provisional application No. 61/238,980, filed on Sep. 1, 2009.

(51) Int. Cl. G08B 1/08

(52) U.S. Cl. 340/539.13

(57) ABSTRACT

A nurse call system includes an integrated locating system. The system includes room-level IR/RFID tracking features. Transition zones incorporate hysteresis to identify transition lines for entering a specific room or location. Capabilities of located persons or assets may be associated with patient treatment plans and/or care alerts based on proximity. Confidence levels may be determined based on information received from multiple tracking systems.

### CROSS-REFERENCE TO RELATED APPLICATIONS

This application claims priority to U.S. Provisional Application Ser. No. 61/238,980, filed Sep. 1, 2009, which is incorporated by reference herein in its entirety.

### TECHNICAL FIELD

The present disclosure relates generally to healthcare communication systems such as patient-nurse communication systems, and more particularly to an integrated nurse call and locating and tracking system.

### BACKGROUND

Hospital staff, including doctors, nurses, physician assistants, orderlies, etc., provide patient care while the patient is undergoing treatment and/or therapy during a hospital visit. A number of systems have been developed to facilitate providing patient care. Healthcare communication systems, including nurse call systems, are one such type of system. Exemplary healthcare communication systems are disclosed in U.S. Pat. No. 5,561,412, U.S. Pat. No. 5,838,223, and U.S. Patent Application Publication No. 2009/0212956. The disclosures of these patents and patent applications are incorporated herein by this reference in their entirety.

Nurse call systems enable communication among members of a nursing staff and other persons dispersed throughout a healthcare facility. Such systems generally provide information about the current status or condition of patients in the facility, and enable voice communication between patients and staff members through a telecommunications infrastructure.

One example of a known nurse call system is Hill-Rom's COMLINX® system. In the COMLINX® system, a “master station” is provided, which is configured to oversee the operation of the system for a specific territory within a facility, such as a nursing unit or units or the entire facility. The master station communicates call information to audio stations that are positioned at various locations throughout the monitored territory.

Locating and tracking systems may interface with a nurse call system to, for instance, determine the location of a caregiver and route a call to the caregiver at that location. For example, U.S. Pat. No. 6,876,303 to Reeder et al. discloses a hospital monitoring system that tracks the location of caregivers on duty, and issues calls to caregivers through a locating and tracking system that is connected to a nurse call system. In Reeder et al., the locating and tracking system and the nurse call system are independent systems that are interconnected by computer network technology. Other exemplary locating systems are described in U.S. Pat. No. 6,539,393 to Kabala, U.S. Pat. No. 5,515,426 to Yacenda, and U.S. Pat. No. 5,455,851 to Chaco. The disclosures of all of these patents are incorporated herein by this reference in their entirety.

### SUMMARY

Disclosed is a integrated healthcare and locating and tracking system incorporating infrared and RFID technology. The disclosed features are directed to reducing the implementation costs of such a system while improving locating accuracy.

According to one aspect, transition zones are defined, incorporating hysteresis to identify transition lines for entering a specific room or location in a facility. The computer may be configured to operate a nurse call system. The system may include a first I/O board coupled to the computer, where the first I/O board includes a first locating and tracking subsystem configured to locate persons or assets, incorporated therein. The plurality of receivers may include a first receiver incorporated into the first I/O board. The first receiver may be an RF receiver.

A second I/O board spaced from the first I/O board, wherein the second I/O board includes a second locating and tracking subsystem configured to locate persons or assets, incorporated therein. The plurality of receivers may include a first receiver incorporated into the first I/O board and a second receiver incorporated into the second I/O board. The first receiver may be an RF receiver and the second receiver may be an IR receiver.

According to another aspect, a decision engine or similar apparatus or mechanism associates capabilities of located assets with patient information, such as treatment plans and/or care alerts, based on proximity. The locating and tracking subsystem may include a plurality of receivers, where each receiver is configured to monitor a defined zone, and at least two receivers monitor each transition zone. Each transition zone may include a physical area that is located in between two zones. At least one of the transition zones may include an area located adjacent an entryway to a room of a healthcare facility. A transition zone may include a portion of a common area located adjacent a door to a patient's room, and/or a portion of the patient's room located adjacent to the door.

According to yet another aspect, confidence levels are determined based on information from multiple tracking systems. The confidence levels may be incorporated into the location determination, and/or may be used in decision making by caregivers or other healthcare facility staff. The system may determine the confidence level by evaluating data from a plurality of locating and tracking mechanisms including an IR locating and tracking mechanism and an RF locating and tracking mechanism. The system may be configured to monitor a plurality of transition zones, where each transition zone includes an area located between zones monitored by different receivers, and the system determines the confidence level of the located person or asset if the located person or asset is in a transition zone.

Patentable subject matter may include one or more features or combinations of features shown or described anywhere in this disclosure including the written description, drawings, and claims.

### BRIEF DESCRIPTION OF THE DRAWINGS

The detailed description refers to the following figures in which:

FIG. 1 is a simplified schematic showing a logical architecture for a patient-nurse communication system in communication with other components of the system;

FIG. 2 is a simplified schematic showing physical components of a patient-nurse communication system and showing connectivity to other services and systems;

FIG. 3 is a simplified diagrammatic view of an exemplary implementation of a patient-nurse communication system in a patient care facility;

FIG. 4 is a block diagram of a locating and tracking system of the patient-nurse communication system; and

FIG. 5 is a flow diagram of a locating and tracking method of the patient-nurse communication system.

### DETAILED DESCRIPTION

Aspects of the present invention are described with reference to certain illustrative embodiments shown in the accompanying drawings and described herein.

The location of caregivers and other hospital staff may be monitored using badges or tags (or other type of wireless signal transmitter) carried by the person. Various wireless technologies may be employed for this purpose, including infrared (IR) and radio frequency (RF) technologies. Infrared signals cannot pass through walls or other solid structures. Thus, if infrared transmitters are used, many IR receivers are required, as an IR receiver must be located in each room in which a monitored person may travel. However, as a result, such configurations are able to determine the location of a person by determining the room in which the person's IR signal is detected.

RF signals can pass through walls or other solid structures. Thus, a monitored person's RF signal may be detected by an RF receiver that is not located in the same room as the person. For example, an RF receiver located in a patient's room may detect an RF signal from a staff member walking down the hallway outside the room. Among other things, this disclosure describes methods and systems for resolving the location of origin of RF signals on a room by room or location by location basis, for use in a healthcare communication system of a healthcare facility.

In general, a healthcare communication system includes one or more staff or nursing computers or computing devices, which may be referred to as stations or consoles. The stations or consoles, in cooperation with various computers, networks, and supporting equipment and services, enable nurses and other staff to receive, view, manage, and route, output or respond to electrical and wireless signals from a variety of communication, call, monitoring, detecting and/or signaling devices. Some communication, call, monitoring, detecting and/or signaling devices are operated by patients, staff, or visitors. Others are activated by the occurrence of an event or condition detected by signal receivers, patient monitoring equipment or hospital beds located throughout a healthcare facility. When the system receives a signal from a communication, call, monitoring, detecting and/or signaling device, one or more indicator assemblies may be activated to alert hospital staff of the condition or event being signaled by the communication, call, monitoring, detecting and/or signaling device.

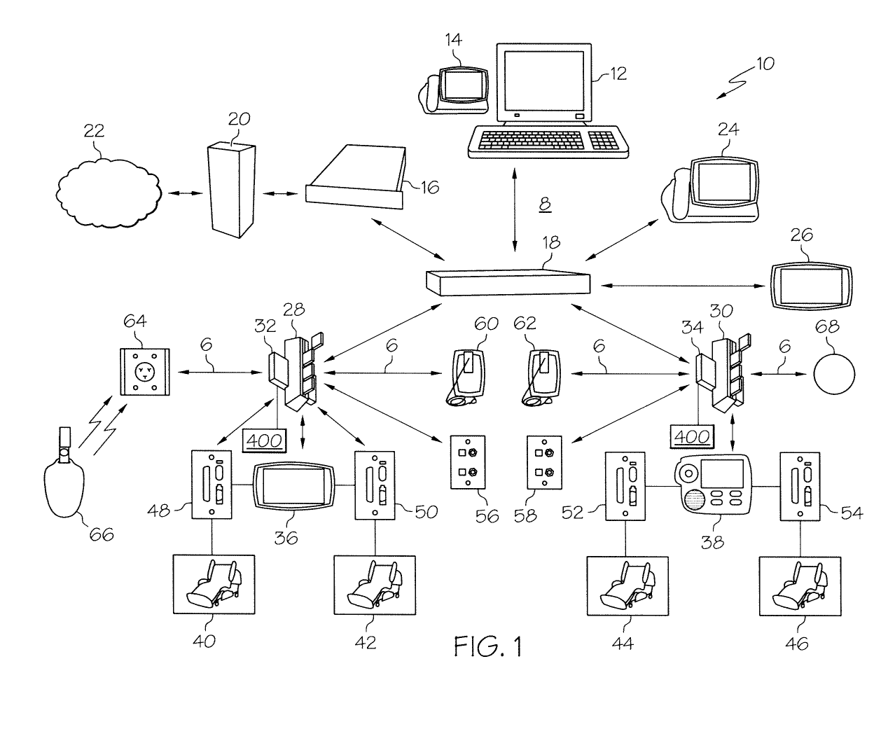

One embodiment of a patient-nurse communication system 10 is diagrammatically illustrated in FIG. 1. System 10 includes a primary user console or station 12, and one or more secondary user consoles or stations 14, 24, 26, 36, 38 which are configured to be operated by nurses or other staff. Primary station 12 enables nurses or staff to monitor activity and communicate with patients and other staff within the facility or portion of the facility monitored by the system. Primary station 12 is a computer or computing device that has a display screen, voice communication capabilities, and one or more input devices (such as a keyboard, touch screen, mouse, switch, button, knob, or the like) configured to control the operation of the patient-nurse communication system. Voice communication capabilities are provided by an integrated microphone and speaker and/or a telephone handset.

Primary console or station 12,14 is configured to enable a nurse or other staff to place calls, cancel calls, monitor the location of other staff members, process calls and alerts and route or relay calls or alerts to and from other consoles or other components of the system. Primary console 12 may further be configured to enable an authorized user to update the status of calls, alerts, monitored persons and/or monitored devices or equipment, and enable or disable calls or alerts. Primary station 14 is configured to be desk-mounted but could also be wall-mounted.

Secondary user consoles or stations 24, 26, 36, 38 have similar components and provide similar but often more limited capabilities than the primary console 12, 14. For example, primary console 12 may include a larger display screen, a graphical user interface configured for data entry, monitoring, and analysis, a network interface (e.g., for TCP/IP connectivity), and/or a telephone handset. However, different configurations of secondary consoles 24, 26, 36, 38 exist that may or may not have a graphical display or telephone handset, or may have limited network connectivity.

For example, console 24 has structural components that are similar to console 14 but generally does not have all the same functional capabilities as console 14 because console 24 is a secondary console. Console 24 may be configured to display only a subset of the information that is available at console 14 (i.e., console 24 may be configured to display only calls pertaining to a particular grouping of patient rooms assigned to a specific nurse, while console 14 is configured to display all call information for all rooms in a nursing unit, group of units or entire facility). Consoles 26, 36 have similar structural components and functional capabilities as console 24 but do not have a telephone handset. Console 38 is a scaled-down and potentially lower cost version of console 24, and as such has more limited graphic capabilities and restricted network connectivity.

Notwithstanding the above description, secondary consoles 24, 26, 36, 38 may have all of the components and functional capabilities as primary console. For example, a console or station may be a primary console for one nursing unit, zone or portion of a facility and also be configured as a secondary console for another unit, zone or portion of the facility. In this way, information for multiple units, zones or portions of a facility may be monitored from one station or console.

Consoles 12, 14, 24, 36, 38 are connected either directly or indirectly (i.e., through an electrical assembly, such as an input-output board) to a switch 18. In the illustrated embodiment, switch 18 is a Power over Ethernet (POE) switch, however, other suitable types of switches may be used, as will be understood by those skilled in the art. Switch 18 and electrical assemblies or input-output boards 32, 34 provide connectivity to a variety of call, communication, monitoring, detecting and/or signaling devices 40, 42, 44, 46, 48, 50, 52, 54, 56, 58, 60, 62, 64, 66, 68 to receive call and/or alert signals therefrom. Switch 18 may also be configured to provide electrical power to remote devices, as is the case with POE switches.

In general, “console” or “station” is used herein to refer to a computer or computing device configured to provide an interface to the system for a user, such as a nurse, staff member, patient, or visitor. As such, these equipment generally include at least one output device, such as a visual display or speaker, to notify or communicate calls and/or other information to the user. Stations or consoles may also include at least one input device, such as a touchscreen, keypad or keyboard, microphone, telephone handset, push button, switch, dial, lever, or the like, to enable the user to place and/or respond to the calls or other information. Stations or consoles also include circuitry to connect them to the system 10. Stations or consoles include embodiments that may be desk- or table-mounted, as well as embodiments that may be mounted to a wall, headwall, column, bed, siderail, or other structure.

Input/output boards 32, 34 are circuit board assemblies that provide computing processing and wiring for a patient location in the healthcare facility, such as a patient room. Among other things, the electrical assemblies or I/O boards operate to convert device-specific protocols from a variety of devices, which may be installed in patient rooms, to a single network protocol suitable for communication over a network. For example, I/O boards 32, 34 convert serial links to primary and secondary consoles, remote locating receiver or bed interface unit room bus protocols, and serial to dome light protocols, on the one side, to XML-over-TCP/IP on the other side. In the illustrated embodiments, each I/O board 32, 34 includes a multimedia microprocessor with built-in multimedia capability, such as the Freescale IMX 27. Input-output boards 32, 34 may also include one or more POE ports to enable devices to connect directly to the board instead of connecting to the system through a switch.

Indicator assemblies 28, 30 are coupled to electrical assemblies or input-output boards 32, 34 and receive control signals therefrom to activate a visual or audible notification, or a combination of visual and audible notifications, at the indicator assembly.

In general, primary console 12 is in communication with electrical assemblies or input-output boards 32, 34 through a computer network 8 and switch 18. Secondary consoles 14, 24, 26, 36, 38 are in communication with primary console 12 over network 8 through a switch 18 and may thereby receive information and commands from primary console 12. In the illustrated embodiment, network 8 is a TCP/IP network running an XML data protocol configured to enable communication among a number of devices and/or systems usable by the healthcare facility.

Call, communication, monitoring, detecting and/or signaling devices include, for example: beds 40, 42, 44, 46 (such as Hill-Rom TotalCare® or VersaCare® beds), which are linked to system 10 via bed interface units 48, 50, audio bed station connectors (ASBCs) 52, 54, or similar bed connector devices; patient monitors and other medical or clinical devices or equipment (such as therapy equipment, heart rate or respiration monitoring devices, and the like), which are linked to system 10 via connectors 56, 58; call cords 60, 62; wireless (i.e. infrared or radio frequency) location tracking receivers or “remote location receivers” 64 and related location tracking badges or tags 66, and smoke alarm 68. Some call, communication, monitoring, detecting and/or signaling devices, such as remote receiver 64, cords 60, 62, smoke alarm 68 and bed interface units 48, 50, are coupled directly to I/O boards 32, 34 by communication links 6. Other devices are coupled to I/O boards 32, 34 indirectly through consoles or stations, such as ASBCs 52, 54, which connect beds 44, 46 to station 38. In the illustrated embodiment, links 6 are RS485 connections.

For ease of description, this disclosure may use “incoming call” or “call” to refer to one or more calls, messages, communications or signals sent from a call, communication, detecting, monitoring, and/or signaling device to system 10, and may use “outgoing notification”, or “notification” to refer to one or more calls, messages, communications, alarm signals, alert signals or other indications or annunciations that are configured to notify or otherwise direct the attention of a nurse or other staff member of or associated with the facility to an incoming call. Further, this disclosure may use “call device” to refer individually or collectively to such call, communication, detecting, monitoring, and/or signaling devices.

As shown in FIG. 1, switch 18 links various components of system 10 to a primary station 12, 14. Primary station 12, 14, alone or in combination with one or more other server computers and/or computing devices, hosts and executes software and services needed to operate system 10. Primary station computer 14 is configured to process control messages generated by system 10 and send them to the appropriate destination or endpoint, such as a secondary console, I/O board, or other electrical assembly. As such, server 14 includes a soft telephony switch and related componentry.

Server 14 is configured to operate and manage many of the primary nurse call functions of system 10, such as receiving and managing messages from various connected devices, synchronizing devices that come online, controlling placement and canceling of calls, answering of calls, generating of notifications or alerts, acknowledging and canceling of notifications and alerts, managing location information for staff and devices, activating and deactivating staff, managing staff-patient assignments, assigning and managing roles and responsibilities to staff and devices, and managing patient information and patient discharges and transfers.

Switch 18 may also link system 10 to an “enterprise” server 16. Enterprise server 16 may be configured to enable system 10 to interface with systems or services that are considered “external” or “optional” to system 10. For example, server 16 may be coupled to a telecommunications server 20, which acts as a gateway to a facility's telecommunications infrastructure 22. Infrastructure 22 generally includes a network that is configured to facilitate communication among a variety of telecommunication devices, including analog and digital devices, fixed telephones and mobile or cellular devices, personal data assistants (PDAs), pagers and the like. For example, infrastructure 22 may include a public switched telephone network (PSTN) or private branch exchange (PBX) or the like.

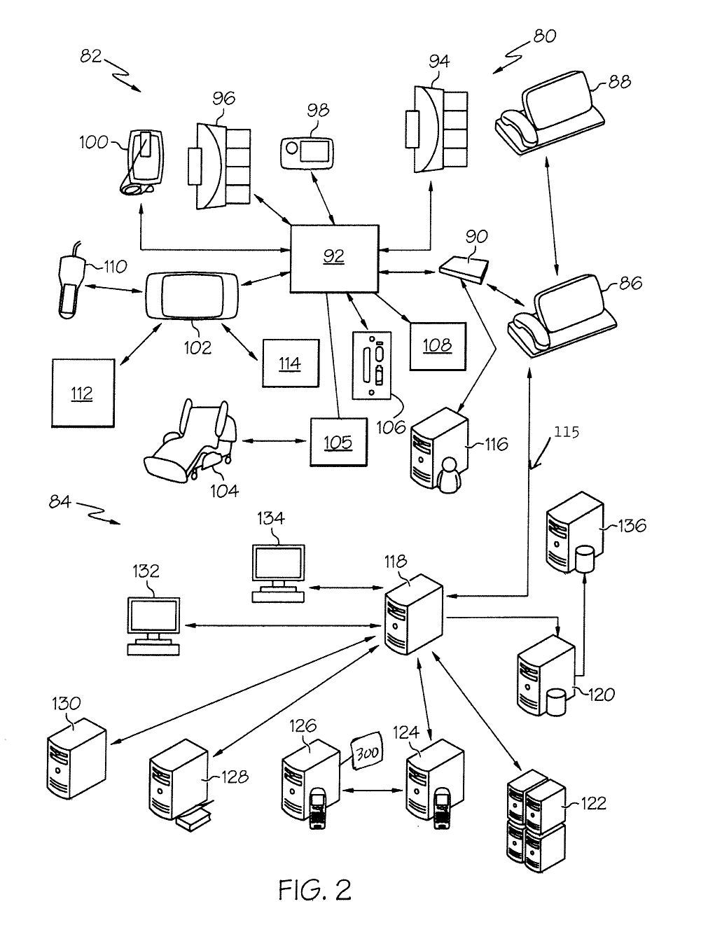

FIG. 2 illustrates connectivity among components of an embodiment of a healthcare communication system 80 including a nurse call system 82 and a plurality of other services and/or systems 84. Nurse call system 82 includes a primary console 86 operably coupled to a switch 90, and a secondary console or station 88 logically coupled to primary console 86 and physically coupled to switch 90. Secondary console 88 is configured to display information about a nursing unit or unit(s) for which it is not the primary console.

Switch 90 is operably coupled to I/O board 92 and server 116. I/O board 92 is configured to receive incoming calls from a variety of devices connected thereto, including but not limited to indicator assemblies 94, 96, secondary console 98, call cord or switch 100, secondary console 102, bed 104, bed interface unit 106, remote locating receiver 108, and pillow speaker 110. In general, these devices are connected to I/O board 92 by an RS 485 link. Additional devices, such as bed connector 112 and call cord 114, may be coupled to or integrated with a secondary console such as console 102 and thereby connected to system 80. One embodiment of an electrical assembly or I/O board is IBM Part No. 43T2063.

An interface 105 is operable to connect bed 104 to I/O board 92. In the illustrated embodiment, interface 105 is a 37 pin connector facing outward that a bed plugs into. On the other side of the plate 105, inside the back box, wires are connected to each pin of the 37 pin connector that could be run to other devices that the bed controls, such as lighting controller, TV, radio, and nurse call patient stations. It may be used in place of a bed interface unit or ASBC.

Server 116 is a VoIP server configured to translate system operations and communications to the corresponding messages that then control endpoint devices, such as nurse or staff stations, consoles or room input/output boards. As such, server 116 includes a soft telephony switch and other associated componentry. Server 116 may also provide integration with the hospital telecommunications structure (e.g., PBX or other voice communication system). In the illustrated embodiment, server 116 is a Windows server running 3CX.

Primary console 86 may optionally be coupled to a second server 118 by a network 115, such as a TCP/IP network. Server 118 may also be coupled to switch 90. Server 118 is similar to enterprise server 16 described above.

According to this disclosure, a wireless communications server 126 for handling communications to and from wireless badges for locating and tracking of staff members is an integral part of the patient-nurse communication system. Other services and systems of system 84 are in communication with network 115 through server 118. Such other services or systems may include a database server 120, one or more third party servers 122, a wireless communications server 124 for managing communications to and from wireless telecommunications devices, a user authentication server 128 for managing user accounts, passwords, and user authorization; a third party product integration server 130, which facilitates integration with third party or legacy products or services; a hospital administrative client 132 for conducting administrative tasks relating to patients and staff, such as adding patients and assigning staff to patients; and a status or reports server 134 for managing displays and reports of calls and notifications for one or more locations in the facility.

While the term “server” is used herein, it will be understood by those skilled in the art that the functionality represented or performed by these elements may comprise software programs or services that may be resident and/or executable by any computer, device or equipment in the system or more than one computer, device or equipment in the network.

In the illustrated embodiment, server 124 is configured to provide communication and configuration for wireless devices using Emergin Wireless Office; server 126 is configured to provide communication and configuration for wireless Vocera devices; server 130 is configured to interface with a Hill-Rom NaviCare system to receive and process alerts therefrom; and server 134 is configured to operate an “electronic status board,” which displays locations within the facility and current information about them, such as active calls, bed status information, staff located in the location, and staff assigned to the location.

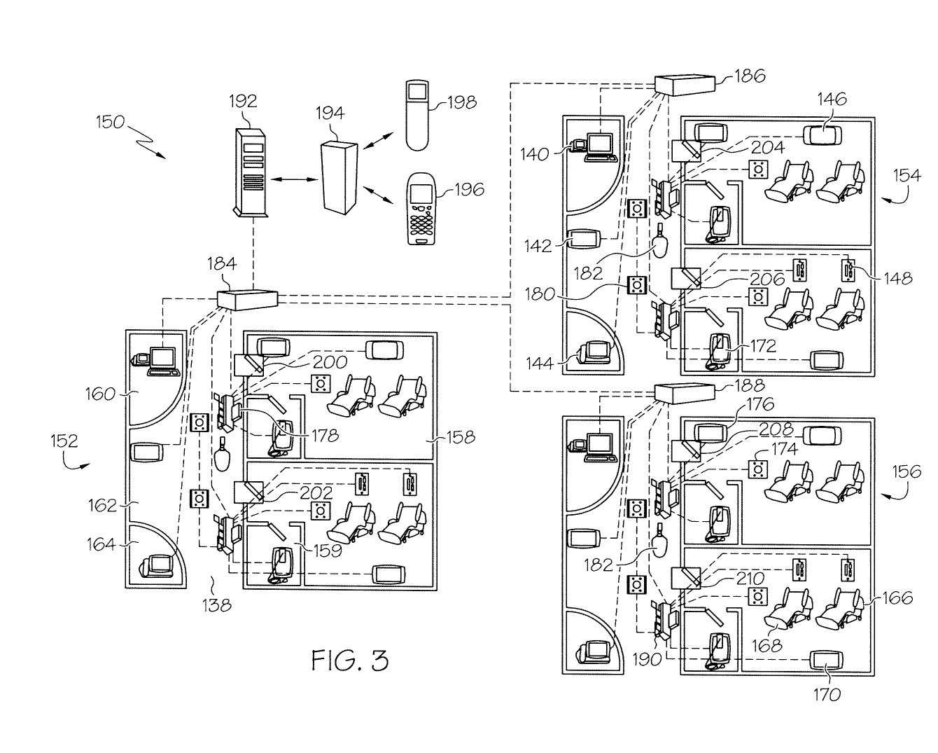

FIG. 3 diagrammatically shows an illustrative implementation in a facility of a healthcare communication system 150 including many of the components described above. The illustrated facility has a plurality of nursing units or zones 152, 154, 156, each of which has one or more patient rooms or locations 158, hallways or common areas 138, and staff locations 160, 164. Each patient room 158 has a bathroom or washroom 159.

A number of call monitoring and/or communication or signaling devices are located throughout the facility, including primary consoles 140, secondary consoles 142, 144, 146, 170, 176, bed interface units 148 and beds 166, 168, toilet, bath and/or shower switches 172, wireless locating receivers 174, 180, and wireless locating transmitter badges 182. In the illustrated configuration, each nursing unit 152, 154, 156 includes a primary console 140, and each patient room includes at least one secondary console 146 and at least one switch 172 located in the bath/washroom 148.

An indicator assembly 190 is mounted in the hallway 138 outside of each patient room 158. Indicator assemblies 190 may be mounted either to a wall or ceiling, above the door to the room or in another suitable location indicative of the patient room with which the indicator assembly is associated. An electrical assembly or I/O board 178 is also associated with each patient room and may be mounted adjacent to each indicator assembly.

Secondary consoles 142, 144 may also be located in hallways 138 and staff locations 160, 164. Locating and tracking receivers 174, 180 are provided in the patient rooms 158, hallways 138 and other locations.

A POE switch 184, 186, 188 is associated with each unit 152, 154, 156 and operably coupled to the devices of its respective unit. System server 192 is coupled to switch 184, which is in turn coupled to switches 186, 188 in the illustrated embodiment. System server 192 is similar to server 118 described above. VOIP server 194 is operably coupled to server 192 and to telecommunications devices 196, 198, substantially as described above.

In operation, when a call or signal is initiated by one of the call initiating devices, executable computer logic processes the call or signal, determines which nurse or staff member to notify of the call, if a notification is necessary, locates the nurse or staff member, and routes an appropriate notification or notifications to one or more output devices associated with the assigned nurse or staff member or within the closest proximity to the assigned nurse or staff member. At the same time, a notification is routed to the output device nearest the location where the call originated. Such computer logic may be located in memory at a primary console, I/O board or at the application server 192.

For example, if a nurse is assigned to units 152 and 156, is currently attending to a patient in room 157 of unit 156, and a patient or piece of monitoring equipment in room 158 issues a call, then system 150 locates the nurse using room receivers 174 and hall receivers 180 and the nurse's badge 182. System 150 then activates the appropriate visual and/or audible notifications at the indicator assembly 178 assigned to the patient room where the call originated. System 150 may activate a visual and/or audible notification at the console 170, nearest the nurse's location, as well. System 150 may cancel or disable one or more of the notifications when the locating receivers detect that the nurse has departed the area or when the nurse enters the room 158 where the call originated.

Each locating and tracking badge or tag 182 includes an active-RFID transmitter. In certain embodiments, tags 182 may be custom developed or supplied by Radianse, Inc. of Andover, Mass. Tags 182 typically transmit signals at a radio frequency in the range of about 433 MHz. Tags 182 are normally made of a durable material such as impact-resistant plastic or the like, are tamper-resistant and programmable. Tags 182 may have one or more buttons or similar controls, which may be programmable by the hospital or health care facility to issue customized alert notifications or other signals to the system 10 or a component thereof. Each tag 182 is programmable for use in locating and tracking a caregiver or other staff member of the healthcare facility, a patient, or a physical asset, such as a hospital bed, medical device or other equipment.

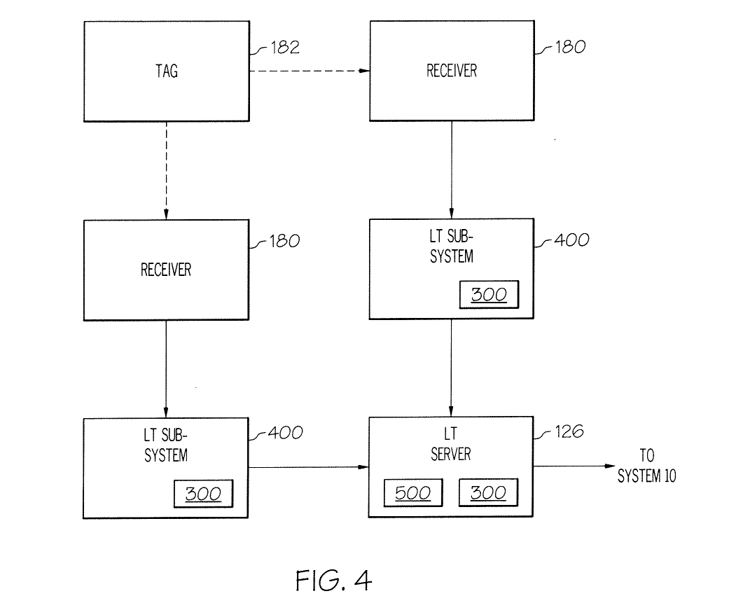

One or more of the locating and tracking receivers 180 receive the RF signals from the tags 182 and communicate electronically with the locating and tracking server 126. The locating and tracking server 126 includes executable programs 300 that track the location of persons and assets carrying the tags 182 in real time. Executable program or programs 300, or portions thereof, may be distributed among the receivers 180 such that each receiver 180 constitutes a locating and tracking subsystem 400 of system 126, as shown schematically in FIG. 4.

In the illustrated embodiment, the RF receivers and subsystems 400 are incorporated into the I/O boards 32, 34, such that the locating and tracking system is completely integrated into the nurse call system. In this way, the need for duplicate wiring, hardware and the like (as is typically required by prior art systems) is eliminated.

The locating and tracking server 126 includes executable program or programs 500 that associate the capabilities of located persons or assets with patient treatment plans, care alerts or the like. In this regard, executable program(s) 500 may include decision support software.

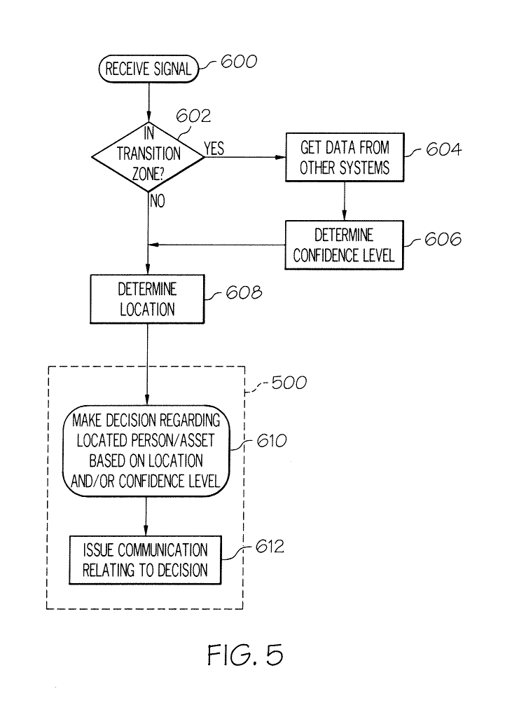

FIG. 5 illustrates steps of a method according to this disclosure. At block 600, one or more receivers 180 receive an RFID signal from an active RFID tag 182. Program(s) 300 determine from the RFID signal whether the tag 182 is in a transition zone (e.g., one of zones 200, 202, 204, 206, 208, 210 shown in FIG. 3). A transition zone refers to an area in between two defined zones, where more than one receiver 180 may detect the signal from the tag 182. As shown in FIG. 3, the transition zones 200, 202, 204, 206, 208, 210 are areas near the entryway from a hallway into a patient room. For example, a transition zone may be defined as the 3 square foot area on either side of the door to a patient room. Hysteresis is incorporated into the location determination in that software 300 incorporates data relating to the previous location of the tag 182 into the location determination.

In one embodiment, if the tag 182 is in a transition zone, then information from other sub-systems 400 that received signals from the tag 182 is evaluated at block 604 and a determination is made at block 606 as to a confidence level associated with the location of the tag 182. For example, referring to FIG. 3, if a tag 182 is in transition zone 200, software 300 will determine a confidence level that the tag 182 is actually located in room 158 and/or a confidence level that the tag 182 is actually located in hallway 138. At block 608, software 300 will determine the location of the tag 182 based on the confidence level or levels previously generated. In each case, the confidence level is determined based on one or more characteristics of the signal received from tag 182 (e.g. the signal strength) and the last known location of the tag 182. The previous location data for each tag is stored in one or more databases or similar computerized data structures of the system 10.

In some embodiments, the confidence level may be determined by evaluating data received from multiple locating and tracking mechanisms. For example, the system 10 includes an infrared locating and tracking mechanism in addition to the active RFID tracking mechanism. Software 300 may evaluate the location information determined by each of these mechanisms to determine the confidence level.

In another embodiment, the confidence level is always determined, regardless of whether the tag 182 is in a transition zone. In this case, the confidence level is determined based on one or more characteristics of the signal received from tag 182 (e.g. the signal strength) by a receiver 180, and the last known location of the tag 182. The previous location data for each tag 182 is stored in one or more databases or similar computerized data structures of the system 10. Each tag is assigned a unique identifier, and an association between the tag identifier and the person or asset being tracked by the tag is made in the database. For example, the database may store both a unique identifier for each tag and for each person or item being tracked by the system 10. When a tag is assigned to a person or asset, the database is updated to associate the tag with the assigned person or asset. A location table or database, or similar data structure, stores location information associated with each RF receiver. As the tag changes location, the database is updated to store the most recent location. The tag's location is determined using a process such as outlined in FIG. 5 and described above.

Once the location of the person or asset being tracked has been determined, software 500 can associate the location information with other information available to it (e.g. using the Navicare® system CareAlerts data or otherwise), to proactively generate care-related suggestions or recommendations related to the tracked person or asset. For example, if a patient has returned to the patient's room, an alert may be issued to the patient's assigned caregiver to activate a feature of the patient's hospital bed, mattress, or other medical device or equipment. For instance, a reminder may be issued to activate a pressure relief or pulmonary therapy (e.g. percussion, vibration, rotation) feature of the patient's bed.

The present disclosure describes patentable subject matter with reference to certain illustrative embodiments. The drawings are provided to facilitate understanding of the disclosure, and may depict a limited number of elements for ease of explanation. Except as may be otherwise noted in this disclosure, no limits on the scope of patentable subject matter are intended to be implied by the drawings. Variations, alternatives, and modifications to the illustrated embodiments may be included in the scope of protection available for the patentable subject matter.

1. A healthcare communication system comprising
a plurality of RFID transmitters carried by persons or assets in a healthcare facility, each transmitter periodically transmitting a transmitter signal unique to that transmitter,
a plurality of receivers, each corresponding to a location in the healthcare facility, each configured to receive the transmitter signals and output a receiver signal, and
a computer configured to substantially simultaneously monitor the location and tracking of persons or assets carrying the transmitters and control patient-nurse communications by defining transition zones within the healthcare facility and determining confidence levels associated with located persons and assets, wherein the confidence levels are determined only if the persons or assets are located in a transition zone.

2. The system of claim 1, wherein the computer is configured to operate a nurse call system.

3. The system of claim 2, comprising a first I/O board coupled to the computer, wherein the first I/O board includes a first locating and tracking subsystem configured to locate persons or assets, incorporated therein.

4. The system of claim 3, wherein the plurality of receivers includes a first receiver incorporated into the first I/O board.

5. The system of claim 4, wherein the first receiver is an RF receiver.

6. The system of claim 3, comprising a second I/O board spaced from the first I/O board, wherein the second I/O board includes a second locating and tracking subsystem configured to locate persons or assets, incorporated therein.

7. The system of claim 6, wherein the plurality of receivers includes a first receiver incorporated into the first I/O board and a second receiver incorporated into the second I/O board.

8. The system of claim 7, wherein the first receiver is an RF receiver and the second receiver is an IR receiver.

9. A healthcare communication system comprising a patient-nurse communication subsystem and a locating and tracking subsystem coupled to the patient-nurse communication system, the locating and tracking subsystem being configured to monitor transition zones and use hysteresis to determine the location of a person or asset being monitored by the locating and tracking subsystem.

10. The system of claim 9, wherein the locating and tracking subsystem includes a plurality of receivers, each receiver is configured to monitor a defined zone, and at least two receivers monitor each transition zone.

11. The system of claim 10, wherein each transition zone includes a physical area located in between two zones.

12. The system of claim 10, wherein at least one of the transition zones includes an area located adjacent an entryway to a room of a healthcare facility.

13. The system of claim 10, wherein at least one transition zone includes a portion of a common area located adjacent a door to a patient's room.

14. The system of claim 13, wherein the at least one transition zone includes a portion of the patient's room located adjacent to the door.

15. A healthcare communication system comprising a combined patient-nurse communication and locating and tracking system, the combined system including a decision engine configured to associate one or more capabilities of a located person or asset with one or more care recommendations and issue an alert regarding the one or more care recommendations.

16. The system of claim 15, wherein the decision engine issues an alert if a located person's location has changed.

17. The system of claim 16, wherein the decision engine is configured to send an alert to a caregiver assigned to the located person if the located person is located in a room assigned to the located person.

18. The system of claim 17, wherein the alert includes a reminder to activate equipment located in the person's room.

19. A healthcare communication system comprising a combined patient-nurse communication and locating and tracking system, the combined system including a program executable to determine a confidence level associated with a located person or asset based on information received from a plurality of locating and tracking mechanisms including an IR tracking mechanism and an RFID tracking mechanism.

20. The system of claim 19, wherein the system determines the confidence level by evaluating data from a plurality of locating and tracking mechanisms including an IR locating and tracking mechanism and an RF locating and tracking mechanism.

21. The system of claim 19, wherein the system is configured to monitor a plurality of transition zones, each transition zone includes an area located between zones monitored by different receivers, and the system determines the confidence level of the located person or asset if the located person or asset is in a transition zone.
